(19) United States
(12) Patent Application Publication
(10) Pub. No.: US 2005/0202291 A1
(43) Pub. Date: Sep. 15, 2005

(54) Shutter mechanism for fuel cell

(76) Inventor: Patrick M. Schweizer, Albany, NY (US)

Correspondence Address: CESARI AND MCKENNA, LLP, 88 BLACK FALCON AVENUE, BOSTON, MA, 02210, US

(21) Appl. No.: 10/796,721

(22) Filed: Mar. 9, 2004

(51) Int. Cl. H01M 8/04

(52) U.S. Cl. 429/13; 429/26; 429/34; 429/38; 429/39

(57) ABSTRACT

A shutter mechanism for use with a direct oxidation fuel cell system is provided within a fuel cell system between the reactant to be controlled and the MEA of the fuel cell. On the anode side, the shutter mechanism can disposed in the vapor gap between a passive mass transport barrier and the anode current collector. This embodiment of the shutter mechanism of the present invention operates in z-axis plane perpendicular to the plate itself and perpendicular to the general direction of fuel flow. In this manner, additional lateral volume is not required for movement of the shutter plate. In accordance with another aspect of the invention, one part of the shutter mechanism is integrated into the current collector, the fuel cell housing, or other component of the fuel cell. In other words, the moving shutter plate has features that correspond with openings in either the anode or the cathode current collector, and such features can be used in conjunction with the current collector to provide control of substances travelling into and out of the fuel cell. The present invention can also be used for heat transfer within the fuel cell system.

### BACKGROUND OF THE INVENTION

1. Field of the Invention

This invention relates generally to direct oxidation fuel cells, and more particularly, to controlling fuel delivery and other substances within a fuel cell system.

2. Background Information

Fuel cells are devices in which an electrochemical reaction involving a fuel molecule is used to generate electricity. A variety of compounds may be suited for use as a fuel depending upon the specific nature of the cell. Organic compounds, such as methanol or natural gas, are attractive fuel choices due to the their high specific energy.

Fuel cell systems may be divided into “reformer-based” systems (i.e., those in which the fuel is processed in some fashion to extract hydrogen from the fuel before it is introduced into the fuel cell system) or “direct oxidation” systems in which the fuel is fed directly into the cell without the need for separate internal or external processing. Many currently developed fuel cells are reformer-based systems. However, because fuel processing is complex and generally requires components which occupy significant volume, reformer based systems are presently limited to comparatively large, high power applications.

Direct oxidation fuel cell systems may be better suited for a number of applications in smaller mobile devices (e.g., mobile phones, handheld and laptop computers), as well as in some larger scale applications. In many direct oxidation fuel cells, a carbonaceous liquid fuel (typically methanol or an aqueous methanol solution) is introduced to the anode face of a membrane electrode assembly (MEA).

One example of a direct oxidation fuel cell system is a direct methanol fuel cell system, or DMFC system. In a DMFC system, methanol or a mixture comprised of methanol and water is used as fuel (the “fuel mixture”), and oxygen, preferably from ambient air, is used as the oxidizing agent. The fundamental reactions are the anodic oxidation of the fuel mixture into CO₂, protons, and electrons; and the cathodic combination of protons, electrons and oxygen into water.

Typical DMFC systems include a fuel source, fluid and effluent management sub-systems, and air management sub-systems, in addition to the direct methanol fuel cell itself (“fuel cell”). The fuel cell typically consists of a housing, hardware for current collection and fuel and air distribution, and a membrane electrode assembly (“MEA”), which are all typically disposed within the housing.

The electricity generating reactions and the current collection in a direct oxidation fuel cell system take place within and on the MEA. In the fuel oxidation process at the anode, the products are protons, electrons and carbon dioxide. Protons (originating from fuel and water molecules involved in the anodic reaction) migrate through the catalyzed membrane electrolyte, which is impermeable to the electrons. The electrons travel through an external circuit, which includes the load, and are united with the protons and oxygen molecules in the cathodic reaction, thus providing electrical power from the fuel cell and water product at the cathode of the fuel cell.

A typical MEA includes a centrally disposed protonically-conductive, electronically non-conductive membrane (“PCM”, sometimes also referred to herein as “the catalyzed membrane”). One example of a commercially available PCM is NAFION® a registered trademark of E.I. Dupont de Nemours and Company, a cation exchange membrane based on polyperflourosulfonic acid, in a variety of thicknesses and equivalent weights. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the liquid fuel mixture across the catalyzed anode face of the PCM, while allowing the gaseous product of the reaction, typically carbon dioxide, to move away from the anode face of the PCM. In the case of the cathode side, a wet-proofed diffusion layer is used to allow a sufficient supply of oxygen by minimizing or eliminating the build-up of liquid, typically water, on the cathode aspect of the PCM. Each of the anode and cathode diffusion layers also assists in the collection and conduction of electric current from the catalyzed PCM.

Direct oxidation fuel cell systems for portable electronic devices should be as small as possible at the power output required. The power output is governed by the rate of the reactions that occur at the anode and the cathode of the fuel cell. More specifically, the anode process in direct methanol fuel cells based on acidic electrolytes, including polyperflourosulfonic acid and similar polymer electrolytes, involves a reaction of one molecule of methanol with one molecule of water. In this process, the oxygen atom in the water molecule is electrochemically activated to complete the oxidation of methanol to a final CO₂ product in a six-electron process, according to the following chemical equation
CH₃OH+H₂O═CO₂+6H⁺+6e⁻ (1)

A passive fuel cell system that uses high concentration fuel without the need for external water recirculation loops was described in commonly-assigned U.S. patent application Ser. No. 10/413,983, filed on Apr. 15, 2003, by Ren et al. for a DIRECT OXIDATION FUEL CELL OPERATING WITH DIRECT FEED OF CONCENTRATED FUEL UNDER PASSIVE WATER MANAGEMENT, which is incorporated herein by reference. That application describes a passive direct oxidation fuel cell system that uses a passive mass transport barrier element disposed between the fuel source and the anode aspect of the catalyzed membrane electrolyte. In some cases, a liquid fuel is delivered directly to the anode aspect of the fuel cell system. In other cases, such as is described in the above-cited patent application, a methanol vapor delivery film (that is sometimes referred to as an “MDF”) is a pervaporation membrane that causes the liquid methanol in the fuel tank to undergo a phase change to a vaporous fuel before it is delivered to the anode aspect of the MEA. This allows for the use of a high concentration fuel while using passive water management capabilities. Fuel is typically delivered at a constant rate. However, in some instances, it is desirable to change the rate of fuel delivery or to shut down the fuel cell system entirely. The efficiency of a direct methanol fuel cell is dependent, in part, upon the amount of methanol present at the anode catalyst. If more methanol is present than is needed for current generation, the excess will instead pass through the catalyzed membrane or otherwise exit the system without generating current. When excess methanol crosses over the catalyzed membrane, it reacts with oxygen in the presence of the catalyst, present on the cathode side, generating heat and water. This reaction is normally not desirable as it leads to wasting fuel and decreasing the efficiency of the system. In addition, excess water could result in cathode flooding, which inhibits the introduction of oxygen to the cathode aspect of the fuel cell, thus limiting performance of the fuel cell. Furthermore, excess heat can result in lower performance of the fuel cell and possible deterioration of some fuel cell component structures. Accordingly, improved control of the flux of methanol that is delivered to the anode aspect of the fuel cell system is needed. One manner of controlling the flow of methanol to the fuel cell system was described in commonly-owned U.S. patent application Ser. No. 10/413,986 of Hirsch et al., filed on Apr. 15, 2003 for a VAPOR FEED FUEL CELL SYSTEM WITH CONTROLLABLE FUEL DELIVERY, which is incorporated herein by reference.

In addition to controlling the flow of fuel into the system, it may also be desirable to control the flow of oxygen into the cathode side of the fuel cell. Oxygen is a component of the cathode reaction and thus an adequate supply is required for optimum fuel cell performance. However, if the fuel cell is shut down, it is desirable to retain hydration of the membrane and thus it is desirable to close the cathode side to prevent or limit the flow of oxygen into the cathode area. One method and apparatus for controlling oxygen flow into the cathode side was described in commonly-owned U.S. patent application Ser. No. 10/607,696 of Beckmann et al., filed on Jun. 27, 2003, for a CATHODE FLUID CONTROLLING ASSEMBLY FOR USE IN A DIRECT OXIDATION FUEL CELL SYSTEM, which is incorporated herein by reference.

It is an important consideration for commercialization of fuel cells that the overall part count of the system remain as low as possible, and that the fuel cell system comply with certain form factors that are typically small such that the fuel cell system can be conveniently disposed within or attached to a portable hand-held electronic device. Some known shutter mechanisms, such as those described above, can require additional volume to accommodate the open-and-close cycle of movement of the mechanism, which results in the shutter components and mechanism adding unwanted volume, price and complexity to the fuel cell system.

Accordingly, there remains a need for a mechanism for controlling the flow of fuel into the anode aspect of the fuel cell system and for controlling the flow of oxygen into and out of the cathode aspect of the fuel cell system, which mechanism consumes minimal volume within the fuel cell system. Furthermore, there remains a need for a mechanism for controlling the flow of fuel and for controlling the flow of oxygen using fewer parts, and which has fewer connections.

It is an object of the present invention to provide a mechanism for controlling the flow of substances within a fuel cell system, which can be disposed on either the anode side or the cathode side of the fuel cell system (or both) and which has a low space and volume requirement and a small part count.

### SUMMARY OF THE INVENTION

The present invention provides a shutter assembly for use with a direct oxidation fuel cell system. On the anode side, the shutter mechanism includes a moving shutter plate that is disposed between a reactant and the MEA. For example, on the anode side, the moving shutter plate is disposed between the fuel source and the anode aspect of the membrane electrolyte, and preferably between the passive mass transport barrier, if any, and the anode current collector. One embodiment of the shutter mechanism of the present invention operates in a z-axis plane perpendicular to the plate itself and in the general direction of fuel flow. In this manner, additional lateral volume is not required for movement of the shutter plate.

In accordance with another aspect of the invention, one part of the shutter mechanism is integrated into a component within the fuel cell, such as the current collector, or within a wall or aspect of the housing of the fuel cell, or otherwise between a reactant the MEA such that it limits or controls the flow of the particular reactant to or from the MEA. In a preferred embodiment, the moving shutter plate is integrated into the anode or cathode current collector. In other words, the moving shutter plate has features that correspond with features such as openings in the component or portion of the fuel cell, such as on either the anode or the cathode current collector, whereby the flow of reactant substances can be sealed off by adjusting the position of the shutter. Accordingly, additional shutter component is not required because its functionality is provided by existing components such as the current collector.

In one embodiment of the invention, the shutter mechanism includes a movable plate that has protrusions that interface with the current collector open areas to seal the openings. The shutter plate component travels in the space between the fuel source and the fuel cell adjusting the rate of mass transport between the fuel source and the MEA. When the plate is in contact with the current collector a seal is formed, shutting off fuel flow from the fuel source to the MEA and stopping water flow from the MEA towards the fuel source. In an alternative embodiment, the openings are located on the moving shutter plate, and the sealing protrusions are disposed on the current collector, or other component. On the cathode side, a similar arrangement can be used to control oxygen flow into the cathode aspect, and to maintain hydration of the membrane electrolyte.

In accordance with yet a further embodiment of the invention, a sliding shutter plate can be disposed generally parallel to one of the stationary current collectors or other components in a fuel cell system. This sliding shutter component has openings that correspond with openings in the current collector such that when the two sets of openings are aligned, apertures are created which allow for the flow of substances into and out of the fuel cell. When the sliding shutter plate is adjusted to a position in which the openings are not aligned, the fuel cell is substantially closed on that side.

The movable plate of the present invention may also be used for thermal transfer within the fuel cell system. In other words, when adjusting the movable plate to a closed position and the protrusions interconnect with the openings in the current collector, for example, to thus substantially collect heat from the current collector. This transfers heat from the current collector to another portion of the fuel cell system, or can be used dissipate heat out of the fuel cell system via the movable plate.

### BRIEF DESCRIPTION OF THE DRAWINGS

The invention description below refers to the accompanying drawings, of which:

FIG. 1 is a top plan view of a fuel cell system incorporating the moving shutter plate of the present invention;

FIG. 2 is a top plan view of the anode current collector used in the embodiment illustrated in FIG. 1;

FIG. 3A is an enlarged view of a portion of the movable shutter plate and adjacent components of the device of FIG. 1, in an open position;

FIG. 3B is the portion of the device of FIG. 3A, in a closed position;

FIG. 3C is a perspective view of one embodiment of the movable shutter plate of the present invention;

FIG. 3D is a cross section of one embodiment of the shutter mechanism of the present invention illustrating the anode current collector openings;

FIG. 3E is a cross section of another embodiment of the invention in which the current collector has triangulated shaped areas to provide further opening surface area of the diffusion layer;

FIGS. 3F and 3G illustrated another embodiment which consumes minimal, if any volume in the z direction in an open and closed position, respectively;

FIG. 4A is a front view of an anode current collector in accordance with the present invention;

FIG. 4B is the back view of the current collector of FIG. 4A;

FIG. 5A is a portion of a top plan view of the sliding shutter embodiment of the present invention in a full open position; and

FIG. 5B is a device of FIG. 5A in a fully closed position.

### DETAILED DESCRIPTION OF AN ILLUSTRATIVE EMBODIMENT

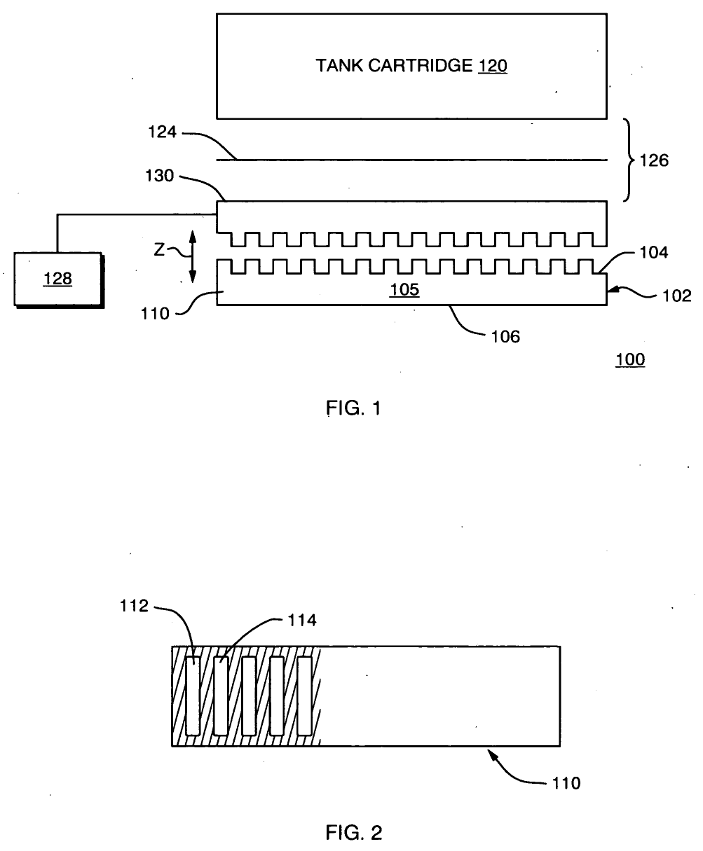

FIG. 1 illustrates a portion of a fuel cell system 100, which includes a fuel cell 102 that has a membrane electrode assembly fabricated using methods and materials known to those skilled in the art. Although not shown separately in FIG. 1, a membrane electrode assembly includes a protonically-conductive membrane such as NAFION®, which is commercially available from E.I. DuPont de Nemours and Company of Delaware, United States of America. A catalyst is disposed on or in close proximity, and preferably in intimate contact with each of the major surfaces of the membrane thus forming a catalyzed membrane electrolyte. The catalyzed membrane electrolyte has a catalyzed anode aspect and a catalyzed cathode aspect. Diffusion layers may also be included. Current collectors, typically comprised of an open conductive structure, as described herein, are used to conduct and collect electrons through an external load.

Fuel is delivered from an associated fuel source or cartridge 120 (FIG. 1A). It should be understood by those skilled in the art that any suitable carbonaceous fuel substance can be used with a fuel cell in which the device of the present invention is employed. Suitable fuels include but are not limited to a liquid fuel, a vapor fuel, a gel fuel or combinations thereof.

In accordance with one implementation of the invention, a passive mass transport barrier element 124 is employed as a methanol delivery film (“MDF”) that effects a phase change on a liquid fuel coming from the fuel tank 120, which then travels into a vapor gap 126 to thereby be delivered to the anode aspect 104 of the fuel cell 102. This provides a path of travel for the vaporous fuel that travels through the barrier layer 124 towards the anode aspect 104 and allows for more even distribution of the vaporous fuel across the anode aspect.

For purposes of illustration, certain aspects of the present invention are described with reference to an anode current collector. It should be understood, however, that the features described can be readily implemented on the cathode current collector, or on the housing of the fuel cell or on another component within the fuel cell system on the anode or the cathode aspect, or both. The other element, i.e., the moving shutter plate, can be disposed in any suitable location within the fuel cell system between the reactant source and the MEA so that flow of the reactant can be effectively controlled.

In the anode current collector embodiment, shown in FIG. 1A, an anode current collector 110 is located at the anode aspect 104 of the fuel cell 102. The anode current collector 110 has a plurality of openings 112, 114, etc. (FIG. 2). These openings also allow for fuel to flow into the fuel cell. In addition, these openings are used by the device of the present invention to effect control of fuel flow into an out of the fuel cell.

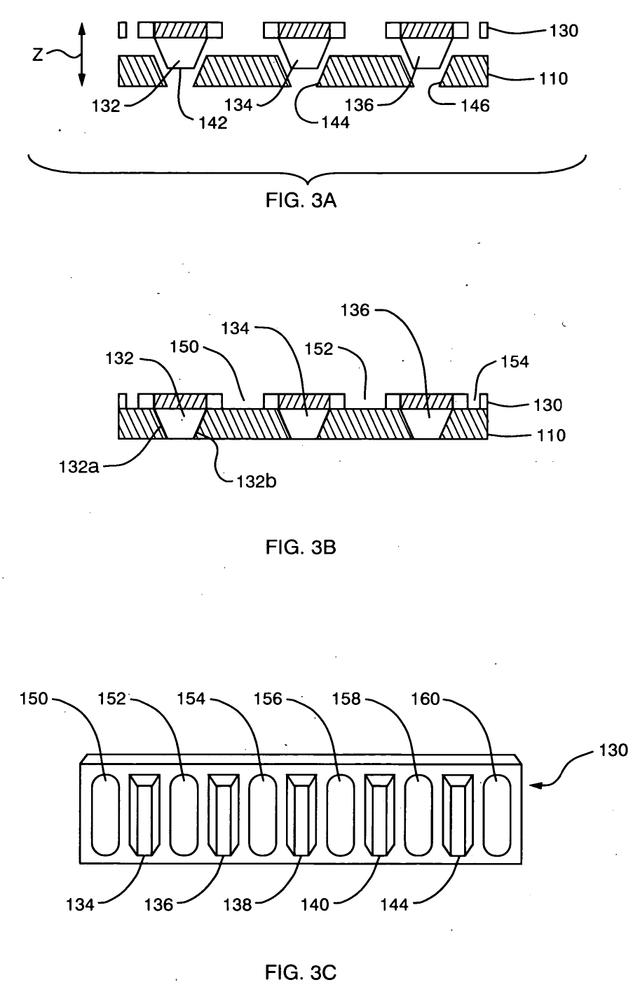

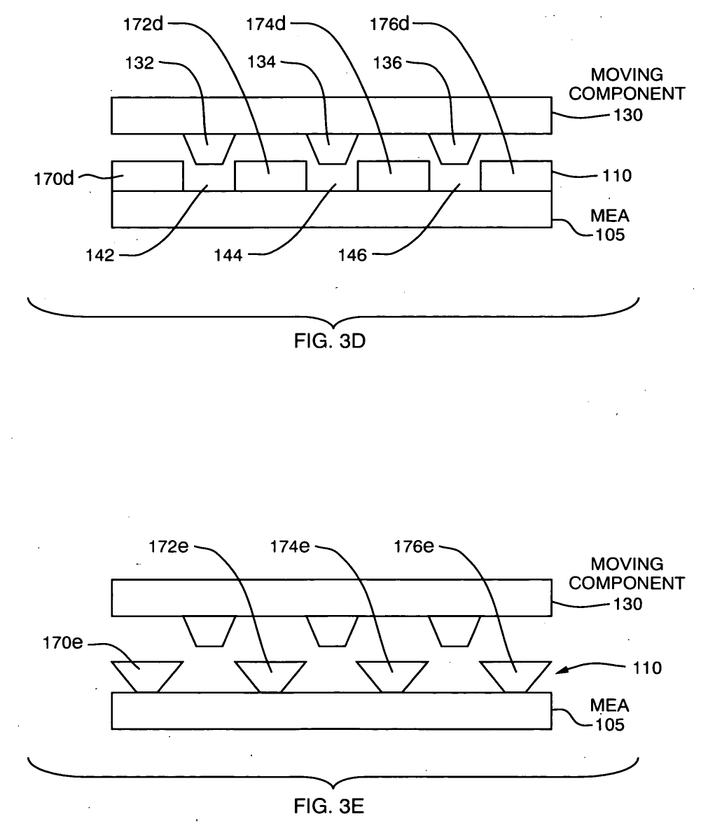

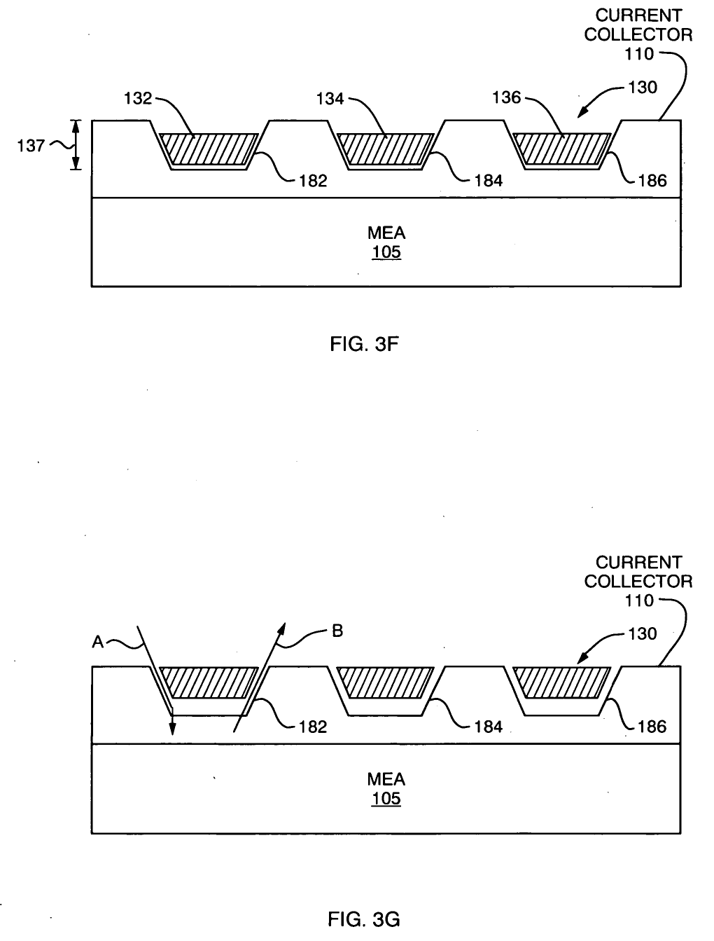

More particularly, referring now to FIG. 3A, (in which like components have the same reference characters as in FIGS. 1 and 2), a moving shutter plate 130 is placed between the fuel source and the anode aspect of the fuel cell, for example within the vapor gap 126. The moving shutter plate 130 includes protrusions 132, 134 and 136. These protrusions are designed to correspond to and interconnect with the anode current collector openings. For example, the protrusion 132 in the moving shutter plate 130 is adjusted such that it closes the opening 142 of the anode current collector in such a manner that it acts as a plug that produces a seal against mass fuel flow between the moving shutter plate 130 and the anode current collector 110. Correspondingly, the protrusion 134 forms a seal in the area 144 and the protrusion 136 forms a seal in the area 146. A closed position is illustrated in FIG. 3B. It may be desirable or beneficial to coat the protrusions, or treat the internal edge of the opening with a pliable material to improve the seal between the opening and the protrusion. As noted above, in an alternative embodiment, the protrusions, such as the protrusion 134 can be disposed on the current collector, while the openings are located in the moving plate, which is moved towards the protrusions and compressed to form a seal against reactant travel.

A perspective view is illustrated in FIG. 3C in which movable plate 130 has protrusions 134 through 144, but also more visible in this figure are the apertures 150 through 160. These apertures 150-160 are offset from the protrusions 134-144 such that when the device is in an open position, the openings allow for fuel to pass through the moving plate towards the membrane electrolyte. In an alternative arrangement, a wick, a capillary pad or other mechanism may used to deliver fuel. In a closed position, the anode current collector prevents fuel from passing through those openings, as shown in FIG. 3B, in which openings 150 through 154 are shown. The specific shapes and number of openings 150 through 154 may vary while remaining within the scope of the invention.

For example, as shown in FIGS. 3A and 3B, the slope of the angled side walls 132a and 132b of protrusion 132, for example, is designed such that a small degree of motion of the movable plate 130 will still allow for an adequate amount of fuel flow, as compared to a moving plate that has more rectangular protrusions, which would be required to be pulled fully away from the current collector to allow for any substantial amount of fuel to be delivered from the fuel source to the anode aspect of the membrane electrolyte.

Several alternative embodiments are illustrated in FIGS. 3D through 3F. In the embodiment illustrated in FIG. 3D, the moving plate 130 has protrusions 132, 134 and 136 as described above. The anode current collector 11—includes openings 142, 144 and 146 in a manner similar to that described above, however, these are defined by a rectangular pattern as illustrated in the cross sectional portions 170d-176d of the anode current collector 110.

A further alternative embodiment of the invention is illustrated in FIG. 3E. In FIG. 3E, the cross sectional portions 170e-176e of the current collector 110 have triangulated shapes. This allows a greater surface area of the anode diffusion layer 180 (which is the uppermost layer of the MEA sandwich 105) to be exposed to fuel, improving the distribution of fuel to the catalyzed surface of the PCM.

In yet a further embodiment, a method that consumes very little z axis volume is further illustrated.

It should be understood that the alternatives illustrated in the figures may be located on the cathode current collector, or can be readily adapted to be located on another component in the fuel cell system, or on the housing of the fuel cell system. A shutter mechanism can be disposed on each of the anode aspect and the cathode aspect to control the reactants in each active area of the fuel cell system, while remaining within the scope of the present invention.

In the embodiment of FIGS. 1 through 3E, there is no additional lateral volume required because the movable shutter plate 130 is disposed within an anode vapor gap 126, which is already in existence within the fuel cell system 100 and it's position is adjusted back and forth within that vapor gap, in a z-axis direction as shown by the arrow z in FIG. 1. Thus, additional lateral volume is not required to accommodate the motion of the shutter mechanism.

In the embodiment set forth in FIGS. 3F and 3G, a shutter mechanism that consumes almost no additional volume in the z-direction is illustrated. More specifically, anode current collector 110 (connected to MEA 105 in a manner similar to that discussed herein) has a plurality of sloped indentations 182-186. The depth of each indentation is illustrated by the dimension 137. The moving shutter plate 130 is formed, in this embodiment, such that when it is in a closed position, as shown in FIG. 3F, it is seated within the recesses 182, 184 and 186, to seal off the flow of fuel. When the moving shutter plate is actuated, its travel remains within the space defined as dimension 137. As illustrated in FIG. 3F, the portions 132, 134 and 136 of the moving shutter plate 130 travel substantially within the space defined by the anode current collector indentations (182-186) without requiring additional z-direction volume. The moving shutter plate 130 in this embodiment could be suitably connected together and to the anode current collector (or other component within the fuel cell system) using methods known to those skilled in the art.

An open position is illustrated in FIG. 3G, in which the arrows A and B illustrate the mass transport of reactants when the shutter is open. As noted with respect to the other embodiments of the present invention, the shutter mechanism illustrated in FIGS. 3F and 3G may also be used on the cathode aspect, or on both the anode and cathode aspect of the fuel cell system, or portions of the mechanism can be integrated into the fuel cell housing or another component within the fuel cell system.

The moving shutter plate 130 of the present invention also provides a thermal advantage in connection with the operation of the fuel cell. As will be understood by those skilled in the art, heat is generated on the MEA, which results in the current collectors absorbing heat and becoming warmer than the ambient environment. For example, the moving shutter plate, which can be moved into contact with the anode current collector 110, can thus be used to transfer heat from the current collector 110 to the moving shutter plate 130, when the moving shutter plate 130 is moved away from the current collector, heat can be released into the environment. Alternatively, this mechanism can be used to transfer heat to other points in the fuel cell system where heating is needed.

As noted, the moving shutter plate 130 can be comprised of any suitable material that does not substantially react with fuel. Examples of such materials are metal, such as stainless steel and polymers such as PTFE, and other plastics that do not react with reactants or products of the reaction in the fuel cell. Metals may be advantageous with respect to heat transfer, while certain polymers may prove less expensive and easier to manipulate. Alternatively, the movable shutter plate 130 can be comprised of a compliant material that can be compressed into the anode current collector as a plug-type device, forming a tight seal.

The operation of the shutter can be actuated from a closed to an open position using in any of a number of suitable arrangements known to those skilled in the art. For example, the actuation of the shutter assembly, illustrated in FIGS. 1 through 3F can be performed by a control system 128 (FIG. 1), which preferably includes a means for acting upon the movable shutter plate 130. The control system 128 may include, for example, mechanical means, such as a wire formed from a shape memory alloy (SMA) such as a nickel-titanium (Nitinol) alloy, which will pull or push the plate 130. Alternatively, a temperature sensitive bi-metal spring can act upon the plate 130 to adjust the positions of the plate. Temperature-controlled systems may, in turn, include a lever or spring. The shutter plate 130 could also be physically moved manually to achieve the desired fuel delivery control.

Alternatively, the movement of the shutter plate 130 may be controlled by servos acting upon the component 130 and/or a motor could pull or push the component. In addition, a gear and lever assembly could also be employed to adjust the location of the movable plate 130.

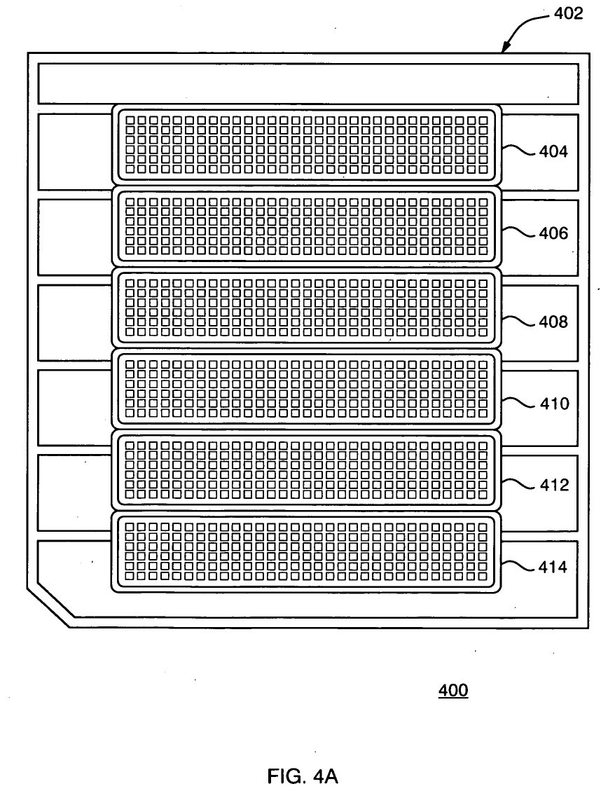

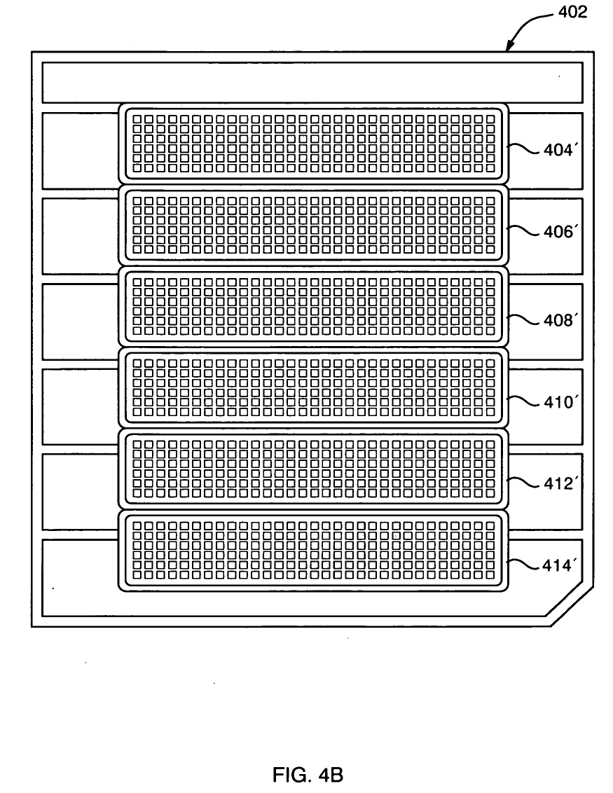

FIGS. 1A-3F illustrate the shutter assembly for a single fuel cell. However, multiple fuel cells may be contained in a fuel cell array, in certain implementations. In such an implementation an anode current collector, for use with a fuel cell array, is illustrated in FIGS. 4A and 4B. FIG. 4A shows the front view of an anode current collector 400. The current collector 400 has an outer frame 402, which provides stability for six individual current collectors 404 through 414. The anode current collectors are thus used with individual fuel cells (not shown).

In accordance with the present invention, one moving shutter plate 130 (FIG. 1) can be used for each of the six separate fuel cells 410 through 414, for example. In an alternative embodiment, one large moving shutter plate could be designed to seal off each of the six separate fuel cells by being pushed down with compression to form a tight seal over the six anode current collectors. The single embodiment has the advantage of reducing the volume as a whole because only one actuator is required to close the seal. In the case of the six separate moving plates, these plates themselves may be of a more simple design, however, six separate actuators or connections from an actuator would be required to close the mechanism. These six separate devices may provide more control in the sense that some could be open and some could be closed for a greater degree of adjustability of the flow of fuel into the overall fuel cell array. Thus, the choice of whether a single or larger moving plate, which would cover more than one of the fuel cells is largely a design choice that could be made based upon the actual implementation of the fuel cell and the application device with which it is used.

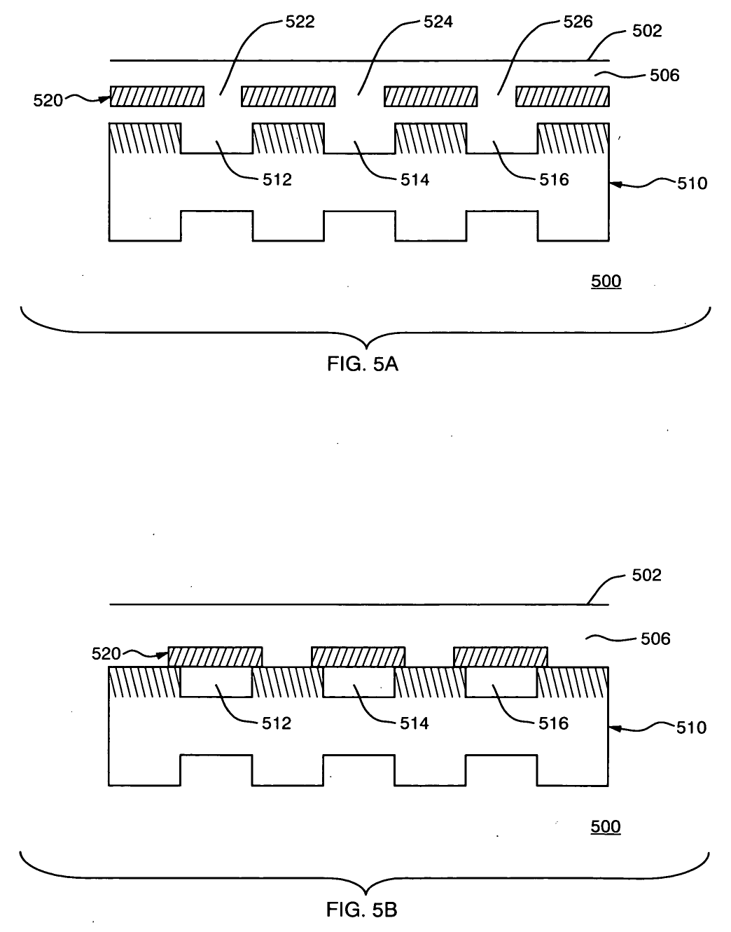

Another embodiment of the invention is described with reference to FIGS. 5A and 5B in which a portion of a fuel cell system 500 is illustrated. In the embodiments illustrated, the fuel cell system 500 includes an MDF 502 through which a liquid fuel is changed to a vaporous fuel which travels into a vapor gap 506, toward an anode current collector 510, which has openings 512, 514 and 516, for fuel flow therethrough. It should be understood, as noted above, that the invention can also be readily employed with fuel cell systems that use a liquid fuel, a vapor fuel, a gel fuel, or combinations thereof. The flow of fuel into the fuel cell through the anode current collector can be regulated in accordance with the invention that includes a sliding shutter plate 520. The sliding shutter plate 520 has holes, or openings 522, 524 and 526 for example, which correspond with the openings 512, 514 and 516 of the anode current collector 510, such that when the openings in both components are aligned, apertures are created, thus allowing for the flow of fuel. This open position is illustrated in FIG. 5A. In contrast, the fully closed position is illustrated in FIG. 5B in which sliding plate 520 has been adjusted to close off the openings 512, 514 and 516 of the anode current collector 510, thus substantially controlling the flow of fuel from passage into the fuel cell, for example, when it is desired to shut down the fuel cell. The openings in the sliding shutter pate 510 are somewhat smaller than the openings (512, 514 and 516) in the anode current collector 510, thus providing a good seal against fuel leakage.

The sliding of the plate 520 may be actuated by any suitable mechanism such as these described above with reference to the other embodiments of the invention.

It should be understood that the embodiments of the present invention just described comprise an implementation that takes advantage of the openings 142, 144 and 146, for example, in the anode current collector 110 which are already there to allow for fuel flow. Thus, the only additional part needed is the movable shutter plate 130 (FIG. 1) with its sealing members that correspond with the openings in the current collector, or the sliding shutter plate 520. These shutter mechanisms for closing the fuel cell thus reducing the part count because there is no need for a separate stationary shutter component.

It should be understood that the present invention is readily adaptable for use on the cathode side of the fuel cell. For example the same type of movable shutter plate 130 illustrated in FIG. 1 may be disposed on the cathode side, for maintaining water vapor within the cathode area of the fuel cell and/or for controlling the flow of oxygen into and out of the fuel cell. For example, when the fuel cell is shut down, it is desirable to maintain the hydration of the membrane electrolyte. In such a case, the shutter mechanism of the present invention, when disposed on the cathode aspect of the fuel cell system is adjusted to its closed position, so that water vapor does not escape thus drying out the membrane. The shutter mechanism may then be actuated to its open position when the fuel cell is powered on to allow oxygen needed in the cathode half-reaction to enter the fuel cell. Alternatively, the sliding plate 520 (FIGS. 5A and 5B) may be disposed on the cathode side to control water vapor and/or oxygen travelling into and out of the cathode area of the fuel cell system. Thus, the shutter plates of the present invention, or any combination thereof, may be employed in a variety of locations on the anode side, the cathode side, or both of any suitable direct oxidation fuel cell system, while remaining within the scope of the present invention.

It should be understood that the device of the present invention provides a simple mechanism for controlling substances flowing into and out of, or within, a fuel cell, and/or fuel cell system and which can be disposed within the fuel cell system between a reactant and the MEA. On the anode side, for example, the inventive device can be disposed generally within the anode vapor gap of the fuel cell system, and it can be designed such that it moves generally within that vapor gap, and does not require additional lateral spacing or volume in the fuel cell system In addition, certain embodiments of the invention utilize the current collectors or other components or aspects of the fuel cell system for one element of the shutter, thus reducing the part count of the fuel cell system. The invention also provides a method of controlling or transferring heat within the fuel cell system.

The foregoing description has been directed to specific embodiments of the invention. It will be apparent, however, that other variations and modifications may be made to the described embodiments, with the attainment of some or all of the advantages of such. Therefore, it is the object of the appended claims to cover all such variations and modifications as come within the true spirit and scope of the invention.

1. A shutter mechanism for controlling reactants in a direct oxidation fuel cell system, having at least one fuel cell including a membrane electrode assembly, comprising:
a moving component disposed within the fuel cell between a source of a reactant and the membrane electrode assembly and said moving component having features formed therein that correspond with features on a receiving element such that when said moving component is placed adjacent to said receiving element, the flow of said reactant is controlled.

2. The shutter mechanism as defined in claim 1 wherein said features on said moving component are protrusions, and said corresponding features on said element are openings, and said protrusions plug said openings when said moving component is placed adjacent to said receiving element.

3. The shutter mechanism as defined in claim 3 wherein said moving component is placed between a fuel source and an anode aspect of said fuel cell, and said receiving element is an anode current collector and when said moving component is placed adjacent to said anode current collector, fuel flow to said anode aspect is restricted.

4. A shutter mechanism for a direct oxidation fuel cell system, comprising:
(A) a fuel source;
(B) a direct oxidation fuel cell, including:
(i) a protonically conductive membrane having catalyst coatings on each of its major surfaces, being an anode aspect and a cathode aspect;
(ii) an anode current collector disposed generally at said anode aspect;
(iii) a cathode current collector disposed generally at said cathode aspect;
(iv) a passive mass transport barrier disposed generally between said fuel source and said anode aspect and spaced from said anode aspect to define a vapor gap in said fuel cell, said passive mass transport barrier controlling a rate of fuel delivery to said catalyzed anode aspect of said fuel cell;
(v) a movable shutter plate disposed within said vapor gap between said passive mass transport barrier and said anode current collector such that said movable shutter plate is adjustable to substantially or partially prevent fuel flow through said anode current collector to the anode aspect of said fuel cell; and
(vi) a load copled between said anode current collector and said cathode current collector for utilizing the electricity generated by the fuel cell.

5. The shutter mechanism as defined in claim 4 further comprising:
said movable plate having a plurality of protrusions disposed thereon that correspond with openings in said anode current collector, such that when said movable plate is adjusted to a closed position, said protrusions interconnect with the openings in the anode current collector to substantially seal said openings, and
said movable plate also having apertures therein interspersed with said protrusions in such a manner that when said movable plate is in an open position, said apertures allow for flow of fuel therethrough; and
said movable plate is adjustable in a direction perpendicular to the plane in which the plate is disposed, such that when it is adjusted, the plate travels generally in a z-axis within said vapor gap, closer to or further away from said anode current collector, to control fuel flow while not consuming substantially additional volume within said fuel cell.

6. The shutter mechanism as defined in claim 5 further comprising:
said protrusions have angled sides; and
said openings in said anode current collector being correspondingly angled such that said protrusions interconnect securely within said angled openings of said current collector to substantially seal said openings against fuel flow.

7. The shutter mechanism as defined in claim 5 wherein said protrusions are substantially comprised of a compliant material that is compressed into said openings when said movable plate is adjusted to a closed position.

8. The shutter mechanism as defined in claim 5 further comprising a coating disposed on the sides of said protrusions in said movable plate which further secures sealing of said anode current collector against fuel flow therethrough.

9. A shutter mechanism for a direct oxidation fuel cell system, comprising:
(A) a fuel source;
(B) a direct oxidation fuel cell, including:
(i) a protonically conductive membrane having catalyst coatings on each of its major surfaces, being an anode aspect and a cathode aspect;
(ii) an anode current collector disposed generally at said anode aspect, said anode current collector having a plurality of openings therein allowing for a flow of substances into and out of said fuel cell;
(iii) a cathode current collector disposed generally at said cathode aspect;
(iv) a movable plate having openings that correspond with openings in said anode current collector and said movable plate being adjustable in a lateral direction that is generally parallel to the plane in which the plate is disposed, such that when the plate is adjusted, the openings in said plate are aligned with the openings in said anode current collector providing apertures for fuel flow, and when said plate is adjusted in an opposite direction, said openings are not aligned such that fuel flow is controlled or substantially prevented from entering said fuel cell; and
(v) a load coupled between said anode current collector and said cathode current collector for utilizing the electricity generated by said fuel cell.

10. A shutter mechanism for a direct oxidation fuel cell system, comprising:
(A) a fuel source;
(B) a direct oxidation fuel cell, including:
(i) a protonically conductive membrane having catalyst coatings on each of its major surfaces, being an anode aspect and a cathode aspect;
(ii) an anode current collector disposed generally at said anode aspect;
(iii) a cathode current collector disposed generally at said cathode aspect;
(iv) a movable shutter plate disposed adjacent to said cathode current collector such that said movable shutter plate is adjustable to substantially or partially prevent oxygen flow through said cathode current collector to the cathode aspect of said fuel cell, and to substantially or partially prevent water vapor from being released from said fuel cell; and
(v) a load coupled across said anode current collector and said cathode current collector for utilizing the electricity generated by said fuel cell.

11. The shutter mechanism as defined in claim 10 further comprising:
said movable plate having a plurality of protrusions disposed thereon that correspond with openings in said cathode current collector, such that when said movable plate is adjusted to a closed position, said protrusions interconnect with the openings in the cathode current collector to substantially seal said openings, and said movable plate also having apertures therein interspersed with said protrusions in such a manner that when said movable plate is in an open position, said apertures allow for flow of oxygen therethrough.

12. The shutter mechanism as defined in claim 11 further comprising:
said protrusions have angled sides; and
said openings in said cathode current collector being correspondingly angled such that said protrusions interconnect securely within said angled openings of said current collector to substantially seal said openings against escape of water vapor.

13. The shutter mechanism as defined in claim 11 wherein said protrusions are substantially comprised of a compliant material that is compressed into said openings when said movable plate is adjusted to a closed position.

14. The shutter mechanism as defined in claim 11 further comprising a coating disposed on the sides of said protrusions in said movable plate which further secures sealing of said cathode current collector.

15. A shutter mechanism for a direct oxidation fuel cell system, comprising:
(A) a direct oxidation fuel cell, including:
(i) a protonically conductive membrane having catalyst coatings on each of its major surfaces, being an anode aspect and a cathode aspect;
(ii) an anode current collector disposed generally at said anode aspect;
(iii) a cathode current collector disposed generally at said cathode aspect, said cathode current collector having a plurality of openings therein allowing for flow of substances into and out of said fuel cell;
(iv) a movable plate having openings that correspond with openings in said cathode current collector and said movable plate being adjustable in a lateral direction that is generally parallel to the plane in which the plate is disposed, such that when the plate is adjusted, the openings in said plate are aligned with the openings in said cathode current collector providing apertures for oxygen flow, and when said plate is adjusted in an opposite direction, said openings are not aligned such that oxygen flow is controlled, and water vapor is substantially prevented from exiting said fuel cell; and
(v) a load coupled between said anode current collector and said cathode current collector for utilizing the electricity generated by said fuel cell.

16. A method of transferring heat in a direct oxidation fuel cell system, including the steps of:
(A) providing a movable plate, said movable plate having a plurality of protrusions disposed thereon that correspond with openings in a current collector of an associated direct oxidation fuel cell;
(B) adjusting said movable plate to a closed position in which said protrusions interconnect with the openings in the current collector to substantially collect heat from said current collector; and
(C) transferring heat from said current collector to another portion of the fuel cell system, or dissipating heat out of said fuel cell system via said movable plate.

17. The method of transferring heat in a direct oxidation fuel cell system as defined in claim 16 including the further step of adjusting said movable plate in a direction perpendicular to the plane in which the plate is disposed, such that when it is adjusted, the plate travels generally in a z-axis, and comes in contact with said current collector to collect heat.
